(19) United States
(12) Patent Application Publication
(10) Pub. No.: US 2002/0196972 A1
(43) Pub. Date: Dec. 26, 2002

(54) Color correction for color devices based on illuminant sensing

(76) Inventors: Gokalp Bayramoglu, Houston, TX (US); Chia-Lin Chu, Cypress, TX (US); Henry M. D'Souza, Cypress, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/894,097

(22) Filed: Jun. 26, 2001

(51) Int. Cl. G06K 9/00

(52) U.S. Cl. 382/167

(57) ABSTRACT

A color correction technique involves sensing an illuminant and performing color correction based on the sensed illuminant. A color output device outputs an image with the color correction based on the sensed illuminant. The illuminant may be sensed in the lighting environment where the color output device is located or may be sensed in the lighting environment where the image is captured by a color digital camera. If an illuminant is sensed in a lighting environment where the image is captured and spectral reflectance data for an object corresponding to the image is detected, then the illuminant information and spectral reflectance data are embedded in the image which is transmitted over the Internet to a user computer system. Color correction software of the user computer system extracts the illuminant information and the spectral reflectance data and performs color correction for the image based on the extracted information. The color corrected image corresponding to the illuminant information is displayed or printed.

### BACKGROUND OF THE INVENTION

1. Field of the Invention

The present invention generally relates to color correction for color devices and more particularly to color correction for color devices based on illuminant sensing.

2. Description of the Related Art

Color management for imaging devices has been widespread among imaging devices including monitors, scanners, digital cameras and printers. Under the color standards promulgated by the CIE (Commission International de l'Eclairage or International Commission on Illumination), colors having the same CIE colorimetry will match if viewed under the same conditions. One such condition is the illuminant or lighting source of the viewing environment. The reference viewing condition for CIE colorimetry—a coordinate system of measurement and quantification of visual color stimuli—is a D50 graphics art viewing environment. D50 is the CIE standard light source for evaluation of color quality and uniformity in graphic arts. A D50 chromaticity represents a specific simulated daylight illuminant (Noon Sky Daylight at 5000K) that can be achieved in an ANSI (American National Standards Institute) standard color viewing booth (ANSI PH-2.30). In such a booth typically having fluorescent D50 simulators, the illumination of imagery is similar to the illumination of the rest of the lighting environment. For a color profile, the illuminant field is usually set to the CIE Illuminant D50 [X=0.9642, Y=1.0000, Z=0.8249]. A viewing environment of imagery, however, may widely differ from the reference viewing environment. Different illuminants or lighting conditions can have a profound effect upon the perception of color for imagery.

Certain color management systems for color printers permit a user to override the reference or default viewing condition by entering an illuminant mode to drive a color printer to produce colors based on the entered illuminant mode. The illuminant modes from which a user may select typically include fluorescent lighting, incandescent lighting, halogen lighting and sunlight. Color correction, however, is not properly accomplished if the entered illuminant mode does not reflect the actual illuminant mode of the viewing environment. That is, color correction and more generally color appearance will suffer to the extent the entered illuminant mode differs from the actual illuminant mode.

Color management systems for color printers that provide for only a user entered illuminant mode also fail to take the illuminant mode in which an image was photographed into account. Color correction thus especially suffers where the illuminant mode in which the image is photographed differs from the illuminant mode entered by the user. Similarly, when a user is viewing an image over the Internet, the user lacks any indication as to the illuminant mode in which the image was photographed.

### BRIEF SUMMARY OF THE INVENTION

A color correction technique involves sensing an illuminant and performing color correction based on the sensed illuminant. A color output device outputs an image with the color correction based on the sensed illuminant. The illuminant may be sensed in the lighting environment where the color output device is located or may be sensed in the lighting environment where the image is captured by a color digital camera. If an illuminant is sensed in a lighting environment where the image is captured and spectral reflectance data for an object corresponding to the image is detected, then the illuminant information and spectral reflectance data are embedded in the image which is transmitted over the Internet to a user computer system. Color correction software of the user computer system extracts the illuminant information and the spectral reflectance data and performs color correction for the image based on the extracted information. The color corrected image corresponding to the illuminant information is displayed or printed.

### BRIEF DESCRIPTION OF THE SEVERAL VIEWS OF THE DRAWINGS

A better understanding of the present invention can be obtained when the following detailed description of the invention is considered in conjunction with the following drawings in which:

FIG. 1 is a block diagram of an exemplary computer-based color correction system with illuminant sensors dedicated to color devices;

FIG. 2 is a block diagram of an exemplary computer-based color correction system with an illuminant sensor shared by multiple color devices;

FIG. 3 is a flow chart of an exemplary color correction technique based on illuminant sensing in accordance with the color correction systems of FIGS. 1 and 2; and

FIG. 4 is a block diagram of an exemplary web-based color correction system involving transmission of a color image containing illuminant information and spectral reflectance data over the Internet; and

FIG. 5 is a flow chart of an exemplary web-based color correction technique in accordance with the web-based color correction system of FIG. 4.

### DETAILED DESCRIPTION OF THE INVENTION

Commonly-assigned U.S. patent application Ser. No. 09/822,094, entitled “AUTOMATIC PRINTER COLOR CORRECTION BASED ON CHARACTERIZATION DATA OF A COLOR INK CARTRIDGE,” filed Mar. 31, 2001, is hereby incorporated by reference as if set forth in its entirety.

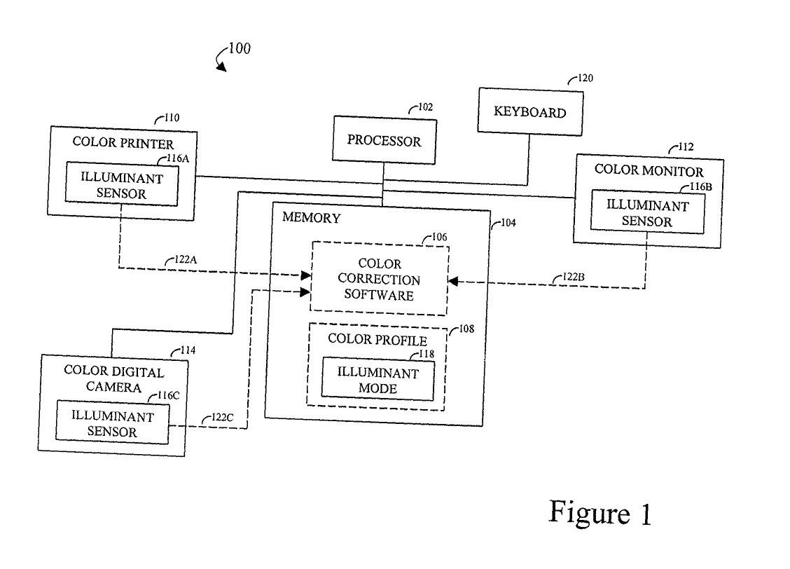

Turning to the drawings, FIG. 1 shows an exemplary computer-based color correction system 100 (computer system) with illuminant sensors dedicated to color devices. Certain typical components of a computer system that are not critical to the disclosed techniques are omitted for sake of clarity. The color correction system 100 includes a processor 102 coupled to a memory 104, a color printer 110, a color monitor 112, a color digital camera 114 and a keyboard or other user input device 120. The color digital camera 114 may be of a type used to capture digital images for video conferencing applications. The memory 104 includes color correction software 106 executable by the processor 102 to perform color correction for the color printer 110, the color monitor 112 and the color digital camera 114. The color correction software 106 may be part of an operating system or alternatively be a distinct application. Microsoft Windows® 98 and 2000, for instance, contain support for ICC (International Color Consortium) profiles in the form of Integrated Color Management (ICM) 2.0 APIs (application programming interfaces). The color correction software 106 includes a profiling capability to profile the camera 114 under the illuminant condition in the viewing environment. In this way, any images captured by the camera 114 are referenced to a known color space. The memory 104 further includes a color profile 108 containing an illuminant mode 118 determined by illuminant sensing with the color correction system 100. Both the color profile 108 and the illuminant mode 118 are described in more detail below. As used herein, the term “illuminant” refers both specifically to a relative spectral power distribution associated with a lighting source and more generally to a particular lighting source itself.

The color printer 110 includes an illuminant sensor 11 6A; the color monitor 112 includes an illuminant sensor 116B; and the color digital camera 114 includes an illuminant sensor 116C. The color correction software 106 receives an illuminant signal 122A from the illuminant sensor 116A, an illuminant signal 122B from the illuminant sensor 116B and an illuminant signal 122C from the illuminant sensor 116C. Each color output device of the color correction system 100 (the color printer 110, the color monitor 112 and the color digital camera 114) thus includes a dedicated illuminant sensor 116 to sense an illuminant or lighting source of a viewing environment. As such, each illuminant sensor 116 in FIG. 1 is part of a color output device. Though illustrated internally with respect to a color output device, each illuminant sensor 116 may alternatively be coupled externally with respect to the color output device. For example, the illuminant sensor 116A may be positioned on top of the printer 110, while the illuminant sensor 116C may be positioned internally with respect to the camera 114. For ease of reference, the illuminant sensors 116A, 116B and 116C are referred to collectively herein as the illuminant sensor 116. Similarly, the illuminant signals 122A, 122B and 122C are referred to collectively herein as the illuminant signal 122.

Each illuminant sensor 116 provides an illuminant signal 122 containing information on the sensed illuminant to the color correction software 106. The color correction software 106 reads the sensed illuminant information from the illuminant signal 122. The illuminant mode 118 of the color profile 108 is determined by the color correction software 106 based on the sensed illuminant information. The color correction software 106 uses the illuminant mode 118 within the color profile 108 to perform color correction in a manner that compensates for the illuminant mode 118. Based on the illuminant signal 122A, the color correction software 106 performs illuminant-based color correction for the color printer 110. Based on the illuminant signal 122B, the color correction software 106 performs illuminant-based color correction for the color monitor 112. Based on the illuminant signal 122C, the color correction software 106 performs illuminant-based color correction for the color digital camera 114. The illuminant signal 122, which may be in the form of CIE (Commission International de l'Eclairage or International Commission on Illumination) tristimulus values (XYZ), generally serves to represent relative spectral power distribution or other characterization data of the particular illuminant or light source of the viewing environment (the room containing the color output device). The color correction system 100 thus employs the illuminant sensor 116, the illuminant signal 122 and the color correction software 106 to perform color correction for the color printer 110, the color monitor 112 and the color digital camera 114 based on illuminant sensing. Stated another way, illuminant information is utilized by the color correction software 106 to drive the appropriate color output device of the color correction system 100.

While color correction for three examples of color devices is represented in FIG. 1, it should be understood that the color correction system 100 may provide color correction for a single color output device or multiple color devices. It should also be understood that color correction employing illuminant sensing may extend to types of color devices associated with a computer system other than color monitors, color printers and color digital cameras, such as a scanner for example.

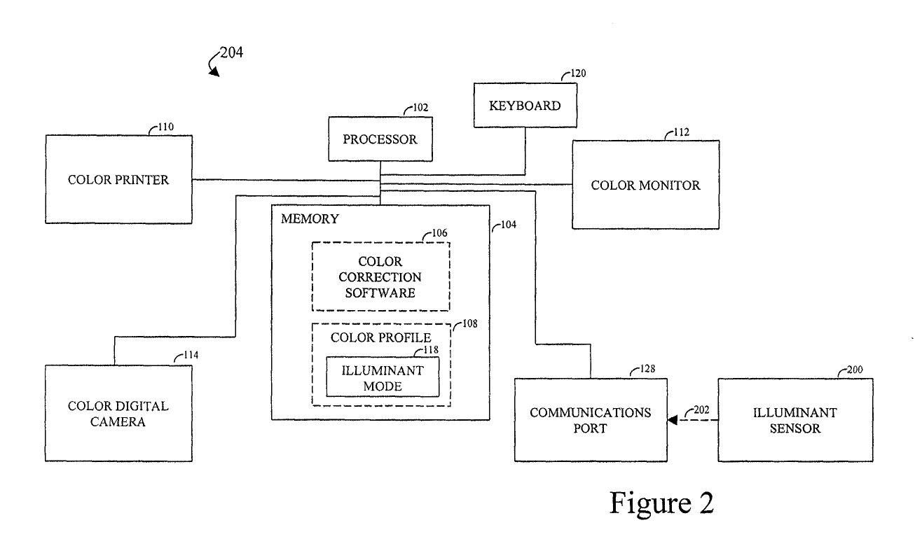

Referring to FIG. 2, an exemplary computer-based color correction system 204 with an illuminant sensor 200 shared by multiple color devices is shown. The illuminant sensor 200 differs from the dedicated illuminant sensors 116A, 116B and 116C in FIG. 1 in that the illuminant sensor 200 is used by each color output device of the color correction system 204. Like in FIG. 1, the color devices shown include the color printer 110, the color monitor 112 and the color digital camera 114. However, unlike the color devices of FIG. 1, the color devices of FIG. 2 do not contain illuminant sensors. Instead, the illuminant sensor 200 is shared by the color printer 110, the color monitor 112 and the color digital camera 114. Since the color printer 110, the color monitor 112 and the color digital camera 114 are within the same viewing environment, the illuminant sensor 200 may be located on top of any of these color devices or similarly located to adequately sense the illuminant of the viewing environment. The illuminant sensor 200 or 116 should generally be of the least size or surface area to adequately discriminate different types of lighting sources.

The illuminant sensor 200 senses an illuminant of the viewing environment and generates an illuminant signal 202 containing the sensed illuminant information which is provided to a communications port 128 of the color correction system 204. If the communications port 128 is an infrared or radio frequency port, a remote connection is employed between the illuminant sensor 200 and the communications port 128. If the communications port 128 is instead a USB (Universal Serial Bus) port or an I.E.E.E. 1394 port (a.k.a. “Firewire”), then a cable is used to provide the illuminant signal 202 from the illuminant sensor 200 to the communications port 128. The communications port 128 directs the illuminant signal 202 to the color correction software 106 which adds an illuminant mode 118 corresponding to the illuminant information in the illuminant signal 202 to the color profile 108. It should be understood that various types of data ports may serve as the communications port 128.

With respect to the illuminant sensors 200 and 116, it should be understood that different types of lighting sources may be discriminated or distinguished in a variety of ways. For example, different types of lighting sources may be discriminated or distinguished by the illuminant sensors 200 and 116 through color temperature (correlated or otherwise), spectral power distribution (relative or otherwise), flickering noise or other characteristics unique to particular lighting sources. Color temperature, usually expressed in kelvins (K), generally refers to the overall color of a lighting source. An exemplary embodiment of the illuminant sensor 200 or 116 may include a filter for each color channel. For instance, three filters may be used corresponding to CIE tristimulus values or RGB (red, green and blue) values. Based on the relative amplitude of the power detected among these filters, different types of lighting sources may be discriminated. An alternative exemplary embodiment of the illuminant sensors 200 or 116 may include a CCD (charge coupled device) scanning array with a different sensor area dedicated for detecting each predetermined wavelength increment (e.g., 40 points) between 400-700 nm. The illuminant sensors 200 and 116 may generally provide a subset or superset of the functions associated with a spectral photometer.

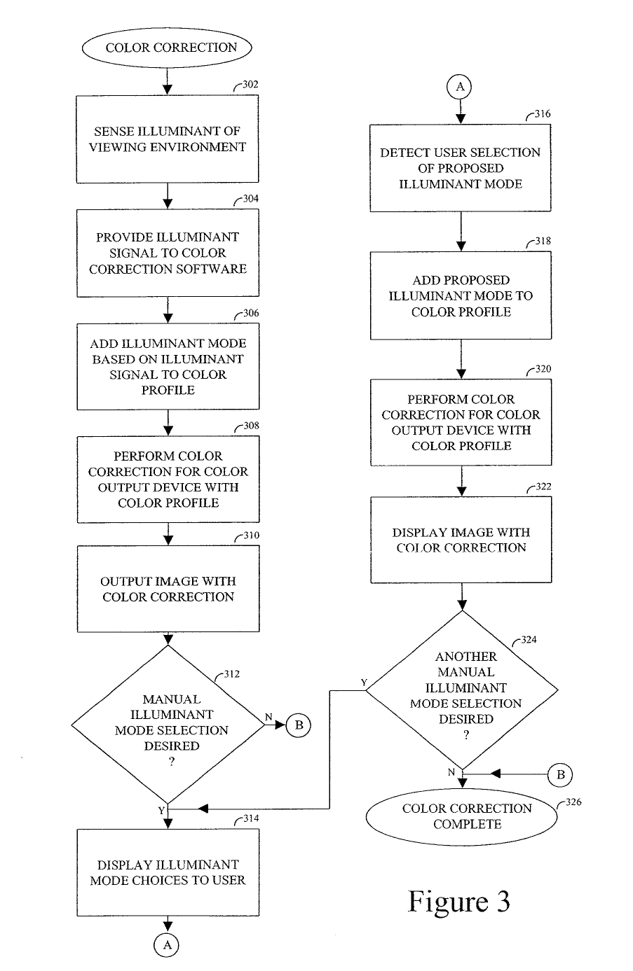

Referring to FIG. 3, an exemplary color correction technique based on illuminant sensing is shown. Beginning at step 302, the illuminant of the viewing environment is sensed by the illuminant sensor 116 or 200. In this way, the actual illuminant of the room where the color output device is located may be obtained as opposed to an illuminant mode entered by a user. Next, in step 304, the illuminant signal 122 or 202 based on the sensed illuminant is provided to the color correction software 106. The remaining steps may be performed by or under control of the color correction software 106. From step 304, the process proceeds to step 306 where the illuminant mode 118 indicated by the illuminant signal 122 or 202 is added to the color profile 108. The standard format for a color profile is described in the International Color Consortium (ICC) Specification ICC.1: 1998-09. The illuminant mode 118 may be provided in an illuminant field of the color profile 108. The illuminant signal 122 or 202 may indicate an illuminant mode such as a fluorescent lighting mode, an incandescent lighting mode, a halogen lighting mode or a sunlight mode. A capability to distinguish more complex illuminant variations may partly depend on the sensitivity and complexity of the illuminant sensor 116 or 200.

In step 308, color correction is performed by the color correction software 106 for a color output device (the color printer 110, the color monitor 112 or the color digital camera 114) with the color profile 108. In general, color correction typically involves use of transformation matrices and/or look-up tables. Next, in step 310, a color corrected image is output by the color output device under control of the color correction software 106. For example, if the color output device is the color printer 110, then the color corrected image is printed on the color printer 110. Similarly, if the color output device is the color digital camera 114, then the color corrected image may be displayed on the screen of the color monitor 112. If the color output device is the color monitor 112, then the color corrected image is displayed on the color monitor 112. Steps 304-310 thus involve an automated mode of obtaining the actual illuminant of the viewing environment and performing color correction with compensation for the illuminant. In this way, color correction for a color output device automatically takes into account that the perceived color of an image depends upon the actual illuminant illuminating the image in the viewing environment.

Steps 312-322 of the color correction process provide for a user to enter an illuminant mode to override the illuminant mode automatically determined by illuminant sensing. This feature may be desirable if the user is for some reason dissatisfied with the color corrected image achieved with color correction based on illuminant sensing. These particular steps are optional in that a color correction system may be implemented that does not allow a user to override automated detection or sensing of the actual illuminant in the room. In step 312, the user is asked if a manual illuminant mode selection is desired. If the user responds through the keyboard or other input device 120 that a manual illuminant mode selection is not desired, then the color correction process is completed in step 326. If the user instead responds through the keyboard 120 that a manual illuminant mode selection is desired, then the process proceeds to step 314 where illuminant mode choices are displayed to the user. The illuminant mode choices represent predetermined illuminant modes such as fluorescent lighting, incandescent lighting, halogen lighting and daylight. One situation where a user may desire to enter an illuminant mode is if the image is to be viewed in a different room from where the color output device is located. In this way, the user may enter the illuminant mode of the intended viewing environment. It should be understood that the process may alternatively handle steps 312 and 314 as one step. Similarly, other steps of the process disclosed in FIG. 3 may be combined or performed in a different order than that illustrated.

Next, in step 316, user selection of a proposed illuminant mode through the keyboard 120 is detected. As used herein, a proposed illuminant mode refers to a user entered illuminant mode proposed by a user for use in performing color correction. The proposed illuminant mode is then added to the color profile 108 in step 318. Following step 318, in step 320, color correction is performed for the color output device with the color profile 108 containing the proposed illuminant mode. From step 320, the process proceeds to step 322 where an image is displayed with color correction based on the proposed illuminant mode to be viewed by the user. In step 324, the user is prompted as to whether another manual illuminant mode selection is desired. If another manual illuminant mode selection is desired, the process returns to step 314. A user thus may manually enter a variety of proposed illuminant modes and view color corrected images under those illuminant modes in an effort to obtain a color corrected image best satisfying the user. If another manual illuminant mode selection is not desired by the user, then the process completes in step 326. In an alternative embodiment, manual user mode selection may be the default approach to obtaining an illuminant mode for a color correction system and illuminant sensing may be an optional approach to obtaining an illuminant mode.

If the color output device is a color inkjet printer, then color correction for the printer may be performed based on characterization data for the color ink cartridge of the printer in combination with illuminant-based color correction. This allows for further improved accuracy in color correction for color inkjet printers. Color correction based on characterization data for a color ink cartridge is described in detail in the commonly-assigned U.S. patent application, Ser. No. 09/822,094, entitled “AUTOMATIC PRINTER COLOR CORRECTION BASED ON CHARACTERIZATION DATA OF A COLOR INK CARTRIDGE.” Similarly, reflectance characteristics of the paper on which an image is to be printed should be taken into account.

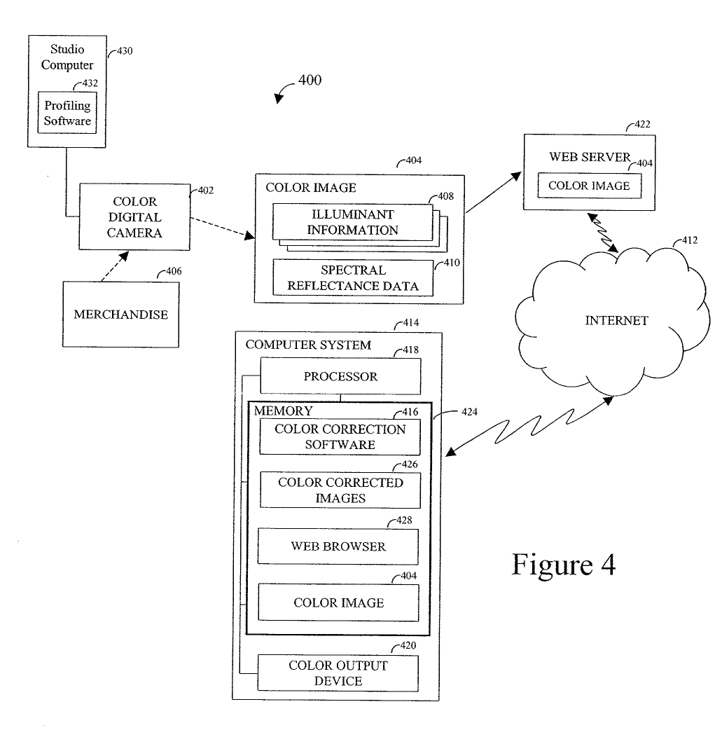

Referring to FIG. 4, an exemplary web-based color correction system 400 is shown. A color digital camera 402 is initially profiled by profiling software 432 of a studio computer 430 in a professional studio environment. More particularly, a color test chart is photographed by the camera 402 and compared to the photograph of the test chart by the profiling software 432. By profiling the camera 402 beforehand, any images captured by the camera 402 will be referenced to a known color space. The profiling is accomplished without any balancing of the white point. It should be understood that under different illuminant conditions the white point and RGB values of the merchandise 406 may differ. The color digital camera 402 is used to photograph an item of merchandise 406 in a lighting environment having a particular illuminant condition. From the perspective of the camera 402, the lighting environments in which the merchandise 406 is photographed are its viewing environments.

The camera 402 includes an illuminant sensor as described above to capture the illuminant information 408 and further includes circuitry for capturing spectral reflectance data 410. As such, the camera 402 may perform a subset or superset of the functions provided by a spectral photometer. The camera 402 is configured through software or hardware to embed the illuminant information 408 and the spectral reflectance data 410 within a color image 404 of the merchandise 406. The illuminant information 408 includes information as to the illuminant condition under which the image of the merchandise 406 is captured. For example, if the merchandise 406 is photographed by the camera 402 under a daylight illuminant condition, then illuminant information 408 as to the daylight illuminant condition will be contained in the color image 404. The spectral reflectance data 410, which contains the spectral reflectance characteristics or coefficients of the merchandise 406, does not depend upon the particular lighting environment. In other words, the spectral reflectance data 410 indicates how the material of the merchandise 406 reflects light. With the spectral reflectance data 410, a new color image of the merchandise 406 can be rendered for a different illuminant condition. The spectral reflectance data 410 basically serves a reference point indicating the desired RGB values. The color digital camera 402 is used in this overall manner by or on behalf of the merchant selling the merchandise 406.

The color image 404 is stored on a web server 422. When the color image 404 needs to be visually presented to a user, such as when the color image 404 is for a web page requested by the user, the color image 404 is transmitted over the Internet 412 from the web server 422 to a web browser 428 in a memory 424 of a user computer system 414. The computer system 414 may belong to a user interested in viewing the picture or image of the merchandise 406 on the color output device 420 in order to make a decision as to whether to purchase the merchandise 406 over the Internet. The memory 424 contains color correction software 416 executable by a processor 418. The illuminant information 408 and the spectral reflectance data 410 are extracted from the color image 404 by the color correction software 416. The software 416 then performs color correction for the image 404 based on the illuminant information 408 and the spectral reflectance data 410, thereby producing color corrected images 426. In other words, color correction compensates for the illuminant condition 400 so that the merchandise looks substantially the same when displayed or printed under different illuminant conditions.

The color correction software 416 also drives a color output device 420 to display or print the color corrected images 426 of the merchandise 406 under the illuminant condition. The color output device 420 may be a color printer, color monitor or other color output device associated with the computer system 414. This technique also addresses the situation where the merchandise was photographed under one illuminant condition and then observed on a user computer system under a different illuminant condition. For example, a user may select to view the merchandise under different types of illuminant conditions such as daylight, fluorescent lighting, incandescent lighting or halogen lighting. In this way, the user is not surprised as to how the color of the merchandise will appear to differ under different illuminant conditions. This reduces the likelihood of the user returning merchandise to the merchant based on any disappointment in the color appearance of the merchandise.

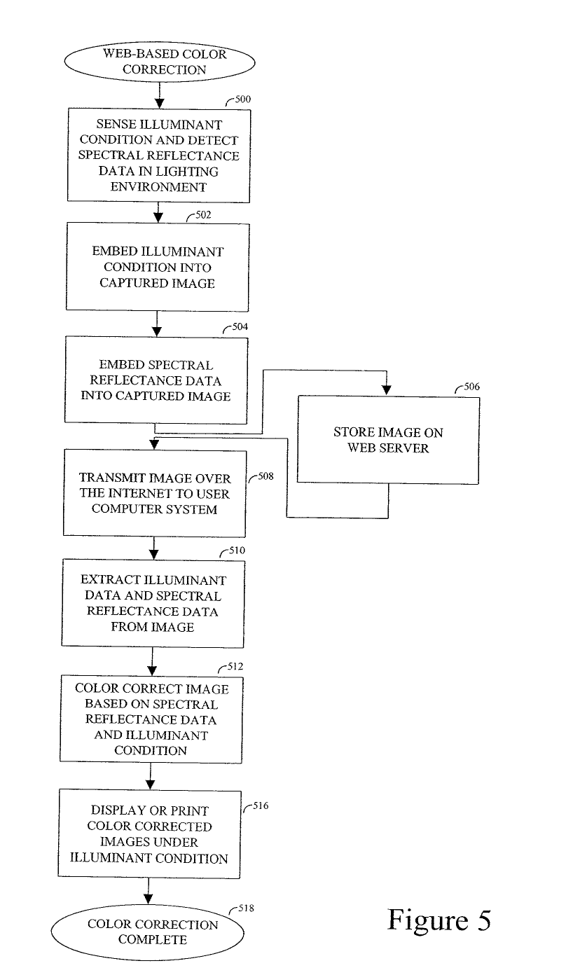

Referring to FIG. 5, an exemplary web-based color correction process is shown. Beginning in step 500, after the camera 402 is profiled, the illuminant condition 408 is sensed and spectral reflectance data 410 is detected in the lighting environment while photographing the merchandise 406 with the color digital camera 402. Next, in step 502, the illuminant information 408 for the lighting environment in which the merchandise 406 was photographed is embedded into the color image 404. It should be understood that the illuminant condition 408 may alternatively be attached or associated with the color image 404 in some other way. Next, in step 504, the spectral reflectance data 410 is also embedded in the color image 404. Following step 504, the color image 404 is stored on the web server 422 in step 506. Steps 502-504 may be handled by a general or dedicated controller of the color digital camera 402.

In step 508, the color image 404 containing the illuminant condition 408 and the spectral reflectance data 410 is transmitted over the Internet 412 to the web browser 428 of the user computer system 414. The illuminant condition 408 and the spectral reflectance data 410 are extracted from the color image 404 by the color correction software 416 in step 510. The color correction software 416 may also retrieve and utilize illuminant information for the lighting environment where the color output device is located such as described in connection with FIG. 3. Next, in step 512, the color correction software 416 performs color correction for the color image 404 based on the spectral reflectance data 410 and the illuminant condition 408. The following exemplary equations generally reflect the relationship between spectral reflectance data, the illuminant condition and tristimulus values:

X=K∫P(λ)I(λ)\overline{x}(λ)dλ

Y=K∫P(λ)I(λ)\overline{y}(λ)dλ

Z=K∫P(λ)I(λ)\overline{z}(λ)dλ,

where K=100/ΣI(λ)\overline{y}(λ)Δλ; X, Y and Z represent the tristimulus values of the merchandise; λ represents the wavelength; I(λ) represents the relative power of the illuminant; Irepresents an integration across the entire visible region; P(λ) represents the spectral reflectance; and \overline{x}, \overline{y} and \overline{z} represent the color matching functions. Tristimulus values generally refer to the amounts of a set of primaries (e.g. red, green, and blue) used to specify color matches. This above set of equations is based on the CIE system.

In step 516, the color corrected image 426 corresponding to the illuminant condition 408 is displayed or printed. Alternatively, in response to a user selection of a desired illuminant condition for viewing a color corrected image 426, the color corrected image 426 associated with the selected illuminant condition is displayed to the user.

To help the user readily associate a displayed color corrected image 426 with the related illuminant condition 408, an illuminant-specific icon may be displayed near the color corrected image 426. For example, the use of a daylight icon or an incandescent icon would permit a user to determine whether a displayed color corrected image 426 corresponds to a daylight illuminant or an incandescent illuminant. From step 516, the process is completed in step 518. By viewing a set of illuminant-specific color corrected images of merchandise, the user can fully visualize the different colors the merchandise may appear under different lighting conditions. This process may be especially helpful to users for whom the exact color of the merchandise weighs heavily into the purchasing decision. Aside from the situation where a user observes a displayed color image of merchandise in considering whether to purchase the merchandise over the Internet, it should be understood that the disclosed techniques apply to a variety of situations where the exact color of an item or image under one or more lighting environments is meaningful or helpful to a user.

The foregoing disclosure and description of various embodiments are illustrative and explanatory thereof, and various changes in the color profiles, illuminant sensors, illuminant modes, lighting environments, color correction software, color management systems, illuminant discrimination techniques, profiling techniques, color coordinate systems, tristimulus values, and color devices, as well as in the details of the illustrated circuitry and software and construction and method of operation may be made without departing from the spirit and scope of the invention.

We claim:

1. A method of color correction, comprising the steps of:
sensing an illuminant; and
performing color correction for a color output device based on the illuminant.

2. The method of claim 1, further comprising the step of:
driving the color output device with the color correction based on the illuminant.

3. The method of claim 1, further comprising the step of:
adding an illuminant mode based on the illuminant to a color profile for the color output device.

4. The method of claim 1, the sensing step comprising the step of:
sensing the illuminant in a lighting environment where the color output device is located.

5. The method of claim 1, the sensing step comprising the step of:
sensing the illuminant in a lighting environment where an image to be output by the color output device is captured by a color digital camera.

6. The method of claim 1, wherein the color output device comprises a color printer.

7. The method of claim 1, wherein the color output device comprises a color monitor.

8. The method of claim 1, wherein the color output device comprises a color digital camera.

9. A color correction system, comprising:
an illuminant sensor to sense an illuminant; and
color correction software, comprising:
code to perform color correction for a color output device based on the illuminant.

10. The color correction system of claim 9, the color correction software further comprising:
code to read the illuminant sensed by the illuminant sensor.

11. The color correction system of claim 9, the color correction software further comprising:
code to drive the color output device with the color correction based on the illuminant.

12. The color correction system of claim 9, wherein the illuminant sensor is part of the color output device.

13. The color correction system of claim 9, the color correction software further comprising:
code to add an illuminant mode based on the illuminant to a color profile for the color output device.

14. The color correction system of claim 9, wherein the illuminant sensor senses the illuminant in a lighting environment where the color output device is located.

15. The color correction system of claim 9, wherein the illuminant sensor senses the illuminant in a lighting environment where an image to be output by the color output device is captured by a digital camera.

16. The color correction system of claim 9, wherein the color output device comprises a color printer.

17. The color correction system of claim 9, wherein the color output device comprises a color monitor.

18. The color correction system of claim 9, wherein the color output device comprises a color digital camera.

19. A color correction system, comprising:
a means for sensing an illuminant; and
a means for performing color correction for a computer system based on the illuminant.

20. The color correction system of claim 19, further comprising:
a means for printing an image on a color printer of the computer system with the color correction based on the illuminant.

21. The color correction system of claim 19, further comprising:
a means for displaying an image on a color monitor of the computer system with the color correction based on the illuminant.

22. A computer system, comprising:
a processor;
a color output device;
an illuminant sensor to sense an illuminant; and
color correction software executable by the processor to perform color correction for the color output device based on the illuminant.

23. The computer system of claim 22, wherein the color output device comprises a color printer.

24. The computer system of claim 22, wherein the color output device comprises a color monitor.

25. The computer system of claim 22, wherein the color output device comprises a color digital camera.

26. A color correction system, comprising:
a means for receiving illuminant information representing an illuminant sensed by an illuminant sensor; and
a means for performing color correction for a color output device based on the illuminant.

27. The color correction system of claim 26, wherein the color output device comprises a color printer.

28. The color correction system of claim 26, wherein the color output device comprises a color monitor.

29. The color correction system of claim 26, wherein the color output device comprises a color digital camera.

30. A method of color correction, comprising the steps of:
reading illuminant information and spectral reflectance data associated with a color image; and
performing color correction for the color image based on the illuminant information and the spectral reflectance data.

31. The method of claim 30, wherein the illuminant information and the spectral reflectance data are embedded in the color image.

32. The method of claim 30, further comprising the step of:
receiving the illuminant information, the spectral reflectance data and the color image from a web browser.

33. A method of illuminant-based color management, comprising the steps of:
sensing an illuminant condition in which a color image is captured by a color digital camera;
detecting spectral reflectance data for an object corresponding to the color image; and
associating the illuminant condition and the spectral reflectance data with the color image.

34. The method of claim 33, the associating step comprising the step of:
embedding the illuminant information and the spectral reflectance data in the color image.
